(19) United States
(12) Patent Application Publication
(10) Pub. No.: US 2020/0301689 A1
(43) Pub. Date: Sep. 24, 2020

(54) SMART DEPLOY AI

(71) Applicant: SmartDeployAI LLC, Southlake, TX (US)

(72) Inventors: Timo Mechler, Southlake, TX (US); Charles Adetiloye, Southlake, TX (US)

(73) Assignee: SmartDeployAI LLC, Southlake, TX (US)

(21) Appl. No.: 16/808,077

(22) Filed: Mar. 3, 2020

Related U.S. Application Data
(60) Provisional application No. 62/919,510, filed on Mar. 18, 2019.

(51) Int. Cl. G06F 8/61; G06N 20/00; G06N 5/04; G06F 9/451

(52) U.S. Cl. CPC G06F 8/63; G06F 9/451; G06N 5/04; G06N 20/00

(57) ABSTRACT

The present invention relates to a method for utilizing an automated process for deploying infrastructure in a computer system. The method may include receiving a request via a graphical user interface (GUI) to obtain one or more containers from a container image registry. The method may also include removing the one or more containers from the container image registry by a processor and managing the other containers with other containers running by a container orchestration system. Further, the method may also include beginning the deployment setup by the processor when the one or more removed image containers are running by preparing necessary user infrastructure and provisioning the necessary user infrastructure onto an external cluster.

### CROSS-REFERENCE TO RELATED APPLICATIONS

This application claims priority to U.S. Provisional Patent Application Ser. No. 62/919,510, filed Mar. 18, 2019, entitled “SMARTDEPLOYAI.” The entire content of that application is incorporated herein by reference.

### BACKGROUND

### Field of the Art

Embodiments of the present invention described herein generally relate to deploying artificial intelligence (AI) and machine learning (ML) data pipelines in the cloud, hybrid or on-premise. Deployments are highly portable and not tied down to any specific configuration.

### Discussion of the State of the Art

Currently, deploying data pipelines for use in AI and ML requires vendor specific knowledge and experience to setup data pipelines and maintain the data pipelines. This knowledge is usually filled by an organization's information technology development operations (DevOps) team, if the organization were to have a DevOps team. Talent for a good DevOps team can be often scarce and the need for complicated DevOps often can add additional cost and setup time to AI and ML projects. The time for the project's pay off period (time to value or time to production) is extended as well.

While some level of automation in the hybrid, cloud, and on-premise infrastructure has been developed, these existing tools are usually vendor or environment specific. As such, data pipeline deployment configurations are made challenging or impossible to generalize or to port to other environments. In many instances, existing solutions are simply not adequate to effectively put an AI and ML into production and also fail due to the necessary insight and tools to maintain and update those models as necessary to ensure acceptable performance and benefit to the business.

### SUMMARY

The present invention overcomes the limitations described above by introducing a method and system for utilizing deploying infrastructure in a computing/mobile computing device. Moreover, the present invention provides a system and method for deploying infrastructure in a computer system. The computer system can receive a request from a user via a graphical user interface (GUI) to obtain one or more image containers from a container image registry. The system and method can also include a processor removing the one or more containers from the container image registry. In addition, a container orchestration system can manage the other containers in the container image registry. The system and/or method can also include the processor beginning a deployment setup by a processor when the one or more removed image containers are running by preparing necessary user infrastructure and deploying the necessary user infrastructure onto an external cluster.

The objectives of the invention are achieved by the embodiments of the present invention. The system and/or method can also include deploying one or more data pipelines. The data pipelines can be a sequence of docker/image containers which are removed from the container image registry and deployed.

The system and/or method can also include installing a smart agent during the deployment setup to collect vital telemetry information from the deployment of the infrastructure and pass the telemetry information to a backend core. A smart agent can be installed to collect information about the deployment of the image containers and/or pipeline and pass that information to the backend core of the computing device.

According to a preferred embodiment of the present invention, the system and/or method can also include monitoring the deployed infrastructure and collecting telemetry information on a state of the deployment setup. A user of the computing device can receive visual feedback on the state of the deployment.

The system and/or method of the present invention can include monitoring health and deployment resource usage patterns. As the user receives visual feedback on the state of the deployment, the user can monitor health and deployment resource usage patterns.

In an embodiment of the present invention, the system and/or method can include selecting an existing pipeline definition to deploy data pipelines. An existing pipeline definition within the application interface can be used to select and deploy one or more data pipelines.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a block diagram with respect to an embodiment of the present invention.

FIG. 2 illustrates a block diagram of an aspect of the present invention.

FIG. 3 illustrates another block diagram of an aspect of the present invention.

FIG. 4 illustrates a flowchart with respect to an embodiment of the invention.

FIG. 5 illustrates a block diagram of an embodiment of the invention.

FIG. 6 is a block diagram of an aspect of the present invention according to a preferred embodiment of the invention.

FIG. 7 illustrates a flowchart with respect to an embodiment of the invention.

FIG. 8 is a block diagram with respect to an aspect of the invention.

FIG. 9 is a block diagram of an embodiment of the invention.

FIG. 10 is a block diagram illustrating an exemplary hardware architecture of a computing device, according to a preferred embodiment of the invention.

### DETAILED DESCRIPTION

The present invention is for deploying data pipelines for use in AI and ML in a computing device or computing system.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Conceptual Architecture

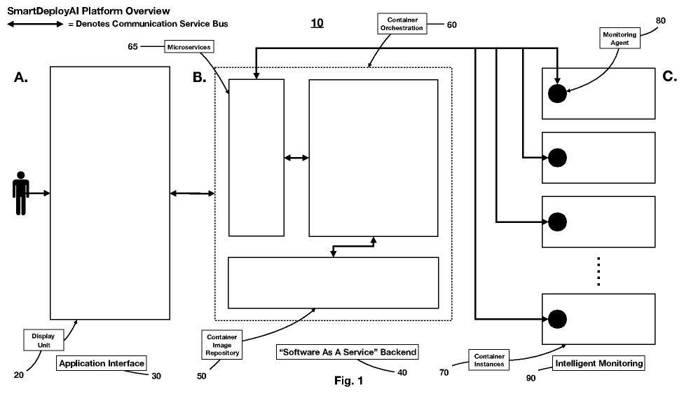

In FIG. 1, a computing device/display unit 10 can be configured to capture and process digital images. The computing device 10 can include a display unit 20 that can display various images. Within the display unit 20, an application interface 30 can be shown. The application interface 30 can include application modules which a user can select to be applied to a backend core 40 of the computing device 10. The backend 40 can include application microservices 45, wherein the backend 40 can include software as a service backend. The computing device 10 can also include a container image repository 50 which can include containers which can be deployed. A container orchestration 60 can also assist in the deployment of the containers which may be deployed from the container image repository 50. Microservices 65 can help arrange the services provided by the container images. The container orchestration 60 can manage the one or more containers that are obtained and deployed from the container image repository 50. Container instances 70 can be further utilized during the deployment of one or more containers. In addition, a smart agent or monitoring agent 80 can monitor the one or more containers during the deployment process and collect vital telemetry information from the deployment setup via intelligent monitoring 90.

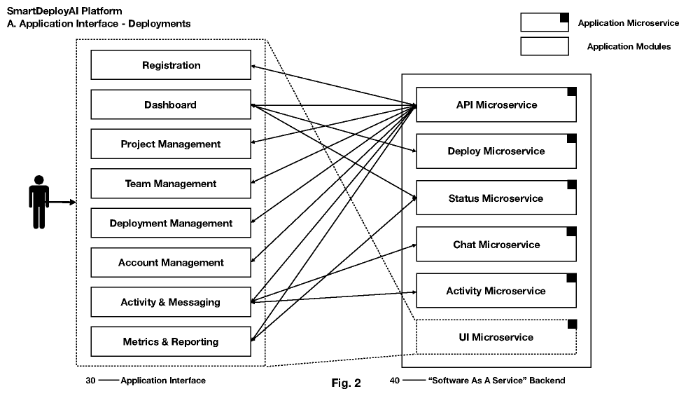

FIG. 2 illustrates the application interface 30 and the backend 40 in more detail. The application interface 30 can include application modules such as registration, dashboard, project management, team management, deployment management, account management, activity and messaging, metrics and reporting. The user can select any one of these application modules which can be applied to the backend core 40. The user can decide to select one of the application modules, or decide to select several of the application modules to be applied to the backend 40. The backend may include a plurality of application microservices. The microservices can include an API Microservice, Deploy Microservice, Status Microservice, Chat Microservice, Activity Microservice, and a UI microservice. The microservices may interact with the application modules and arrange the services that can be associated with each application module.

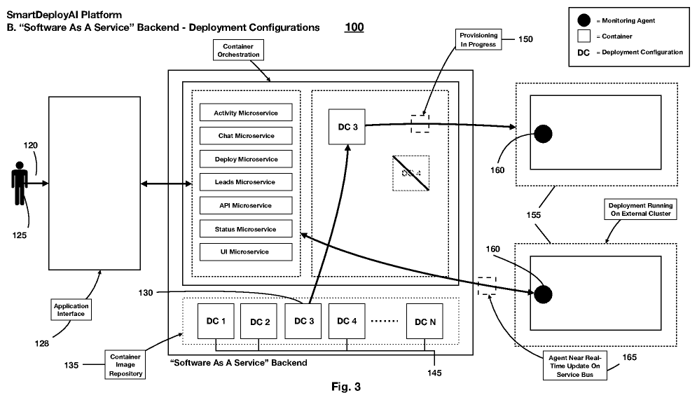

Referring to FIG. 3, a deployment configuration is illustrated in more detail. A computing device 100 can receive a request 120 from a user 125. The user 125 can interact with an application interface 128. The application interface 128 can present the list of application modules described above in FIG. 2. The user 125 can select one or more of the application modules. Further, the user's 125 request can also include obtaining at least one image container 130 from a container image registry 135. After the request is received, at least one of the containers 130 can be removed from the container image registry 135. The selected container 130 can be managed with other containers that are being run by a container orchestration system 140. The container orchestration system 140 can manage the other containers 145 in addition to the selected container 130 obtained from the container image registry 135. The process of removing one or more containers 130, 145 may be repeated as many times as required or as the user 125 may desire. A processor within the computing device 100 may begin the deployment setup.

The deployment setup begins when the selected image container 130 from the container image registry 135 is running, and when the processor within the computing device 100 prepares the necessary infrastructure. The provisioning 150 of the image container 130 can occur during the deployment process. In addition, a monitoring agent can monitor the necessary infrastructure. Further, telemetry information (collection of measurements at remote points) on a state of the deployment setup may be collected. Further, after the necessary user infrastructure has been prepared and the deployment setup is complete, the image container 130 may then be destroyed. The deployment process may be repeated as many as necessary with the other image containers 145. In addition, once a deployment process is complete, each of the other image containers 145 that are removed from the container image registry 135 may be destroyed.

The deployment setup may prepare the necessary user infrastructure in a hybrid configuration. In an embodiment, the deployment setup may also prepare the necessary user infrastructure in a cloud configuration or external cluster 155. During the deployment setup, a smart agent 160 may be deployed. The smart agent 160 may be installed during the deployment setup to collect vital telemetry information from the deployment setup. The smart agent 160 may collect the telemetry information from the deployment setup and pass the telemetry information back to a backend core. The smart agent 160 may also be near a real-time update 165 on a service bus.

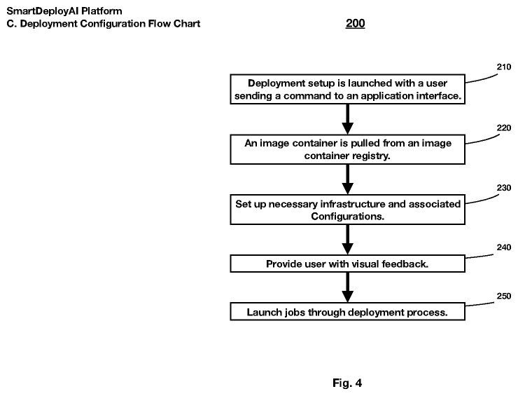

FIG. 4 illustrates a method 200 for registering a deployment of infrastructure within a computer-readable medium that can occur. In step 210, a deployment setup is launched with a user sending a command to an application interface. At step 220, an image container is pulled from an image container registry. Necessary infrastructure and associated configurations are set up at step 230. At step 240, the user is provided with visual feedback of the deployment process.

The visual feedback may include the state of the deployment process inside of the application interface and the health and deployment resource usage patterns. The user may also be able to see the state of the deployment process inside of the application interface. Accordingly, a user of said desktop or mobile device may be able to see the state of the deployment process taking place inside of the application interface. A user may also be able to monitor health and deployment resource usage patterns. At step 250, the user may launch one or more jobs on their deployment process through the application interface. The user is not limited to the number of jobs that he/she may choose to launch during the deployment process. The user may also monitor the progress of the jobs that he has launched on the deployment process. Once the deployment process is complete, the user may choose to delete any infrastructure created by the deployment process. The user may choose to delete any of the newly created infrastructures which he/she feels may no longer be required. The user may also choose to begin an additional deployment process once the original deployment has been completed.

A user may also wish to deploy data workflow pipelines instead of single containers as described above. End to end AI and ML workflows can include data ingestion, transformation, model training, model validations, and model serving. Monitoring facilities can be put in place as part of a workflow pipeline to make sure the model is performing as expected, and not developing bias. A key advantage is that data workflow pipelines are made up of different stages or components. These components can be developed independently by different development teams and interchanged as needed. For example, if a data scientist would want to run a data workflow pipeline and the data ingestion team has developed a version of their ingestion stage/component, the data scientist can choose to run the pipeline with this new component or use the existing component. The decoupling and relative versioning can greatly drive efficiency and team agility. Another advantage can be the ability to easily run multiple experiences. When pipelines are run the infrastructure is instantiated and then quickly torn down once the run is over. AL and ML development time can be sped up. The running of multiple pipelines can reduce total time needed to operationalize the AI and ML process. Since data workflow pipelines consist of connected containers, they can run on all major cloud platforms and on on-premise that can have a container management/orchestration system. Data workflow pipelines allow AI and ML models to be operationalized (put into production) more quickly and provide the needed ability to scale across an entire organization to integrate AI and ML into existing business processes.

Data workflow pipelines can also be executed in several ways. In an embodiment, the data workflow pipeline can be executed on a SmartDeployAI application that includes all related infrastructure. In this embodiment, the resources that are defined within the containers will be instantiated on the SmartDeployAI.

Still in another embodiment, the data workflow pipeline can be executed on the SmartDeployAI, whereas the resourced defined within the pipeline stages (containers) can be instantiated on a customer environment. For instance, one of the stages within the pipeline may require a graphical processor unit (GPU) or tensor processing unit (TPU) to be deployed. The data workflow pipeline can then be instantiated on the customer environment through a smart agent or smart monitoring daemon that is deployed when the external infrastructure of the external customer environment is created. Moreover, the smart agent or smart monitoring daemon can be bootstrapped onto the infrastructure when it is first instantiated to collect valuable status and telemetry data. According, the valuable status and telemetry data can provide the SmartDeployAI application and the user with valuable feedback on the status of any jobs that may be running on the external environment. The status can include whether a job has started, completed, or even failed and whether the external resource environment is ready to process jobs or is unresponsive to processing jobs.

In yet another embodiment, the SmartDeployAI application can be run on-premise or a different cloud provider other than Google Cloud Platform (GCP). The SmartDeployAI can also be run for example on Amazon Web Services (AWS) or Microsoft Azure. In this embodiment, the data workflow pipelines can be run as the infrastructure would be deployed in the respective cloud environment (AWS, Microsoft Azure, etc.)

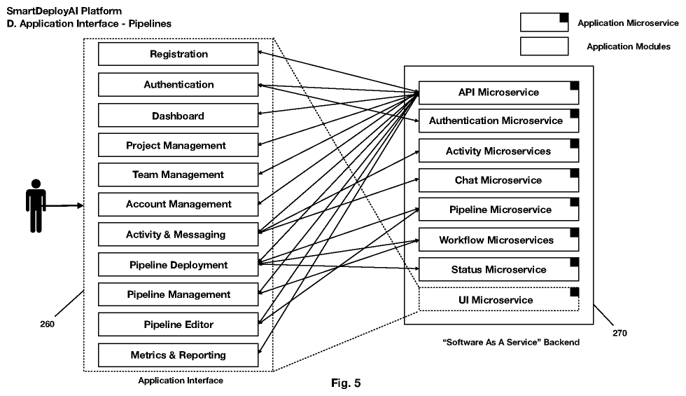

FIG. 5 illustrates another embodiment of an application interface 260 and a backend 270 in more detail. The application interface 260 can include application modules such as registration, dashboard, project management, team management, deployment management, account management, activity and messaging, metrics and reporting as in FIG. 2. In addition, the application modules can also include a pipeline deployment, pipeline management, pipeline editor, and an authentication module. As in FIG. 2, the user can select any one of the application modules to be applied to the backend core 270. The microservices can include an API Microservice, Authentication Microservice, Activity Microservices, Chat Microservice, Pipeline Microservice, Workflow Microservices, Status Microservice, and a UI Microservice. The microservices can arrange the services associated with each application module. For instance, the Workflow Microservice can enable the data pipeline workflow runs to be scheduled for deployment when the pipeline deployment module is selected. The Pipeline Microservice can also help arrange the services provided by the pipeline deployment module, pipeline management module, and the pipeline editor module.

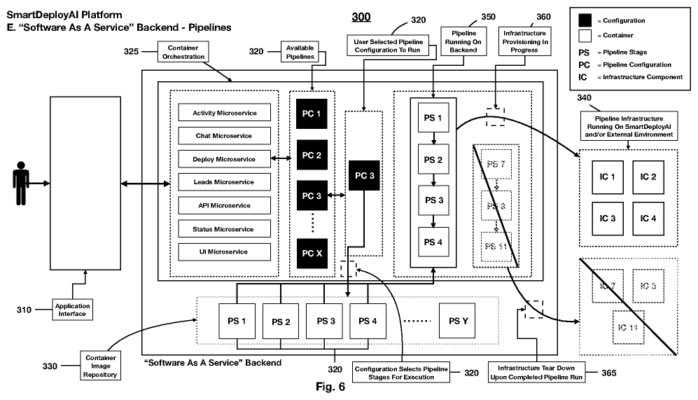

In FIG. 6, an implementation of the deployment of data workflow pipelines is illustrated. A user can upload a pipeline configuration/definition onto the computing device 300 using the application interface 310. The user can also select an existing pipeline configuration by sending a command to the application interface 310. Inside the application interface 310, the user can have the option to instantiate or run the data workflow pipeline they have chosen. Once the user has chosen to run the pipeline, the data workflow pipeline can be instantiated inside the user's environment. Accordingly, the selected pipeline configuration file can be processed. Image containers 320, which represent pipeline stages, can be pulled from an image container registry 330. The selected pipeline 320 can also have a container orchestration 325 within the computing device 300. Accordingly, pipeline stages 320 can be instantiated on the external user environment 340. Further, the pipeline stages 320 can also run on the backend 350, and with infrastructure provisioning 360, also run on the external user environment 340. As with single image containers described above, the instantiation of infrastructure can involve the retrieval and deployment of docker/image containers. In this embodiment, the docker containers can make up the different states of the pipeline stages 320.

Each pipeline 320 can have as many stages as may be required. Once the pipeline stages with docker containers have been deployed, the pipeline 320 can be executed. In an embodiment, the stages of the pipeline 320 can be executed beginning with the first stage, and ending with the last stage of the pipeline 320. Nevertheless, in another embodiment, the stages of the pipeline 320 can occur in parallel, where one or more of the stages are executed at the same time and in no set order. Depending on the type of deployment that a user may desire, the pipeline 320 can be executed with multiple stages sequentially or in parallel with no set order of the execution of the stages. The infrastructure from the pipeline 320 can be deleted or torn down 365 once the run of the pipeline 320 has been completed.

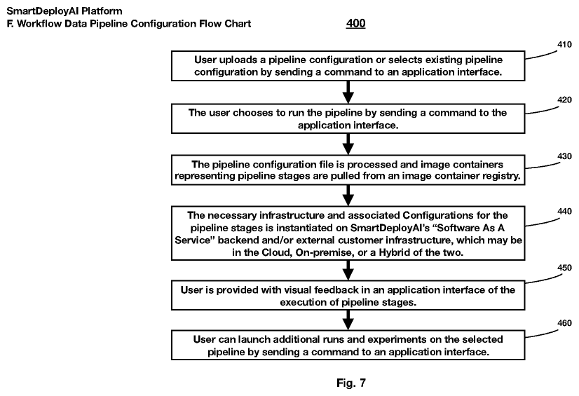

FIG. 7 illustrates a method 400 of the deployment of the data workflow pipelines. At step 410, a user uploads a pipeline configuration or selects an existing pipeline configuration by sending a command to an application interface. At step 420, the user can choose to run the data workflow pipeline by sending a command to the application interface within the computing device. At step 430, the pipeline configuration file is processed. Image containers that represent pipeline stages are pulled from an image container registry. At step 440, the necessary infrastructure and associated configurations for the pipeline stages can be instantiated on the external user environment. As the pipeline stages are executed, they can be instantiated on the backend and also on the external user environment. At step 450, a user can be provided with visual feedback of the execution of the pipeline stages. The user can see the execution of the stages of the data workflow pipeline. In addition, the user can monitor the execution of each pipeline stage. The user can also receive feedback on the execution of the pipeline stages. At step 460, the user can launch additional runs and experiments on the selected pipeline by sending one or more commands to the application interface.

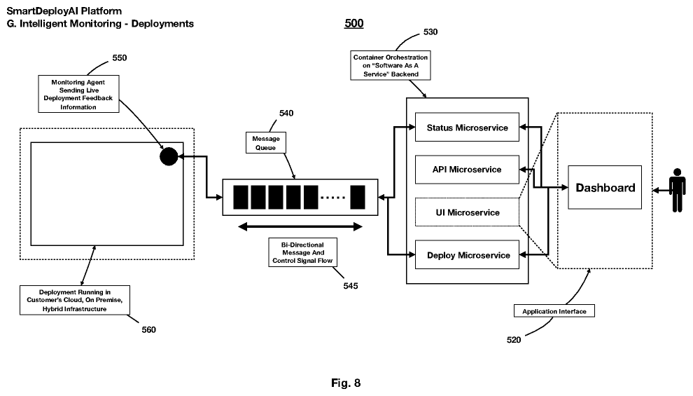

In FIG. 8, a system 500 that enables a user to receive live deployment feedback information is illustrated. The system 500 can illustrate increasing a rate of deployment of computer infrastructure in a computer-readable medium. A user can access an application interface 520 to interface with during a deployment process. Further, a container orchestration 530 with one or more microservices can arrange the services of the various application modules (as illustrated above in FIG. 2) which the user can decide to select from the application interface 520. A message queue 540 can pass deployed infrastructure and other information with a bi-directional message and control signal flow 545 to both the container orchestration 530 and to an intelligent monitoring agent 550. Accordingly, the system 500 may also include the intelligent monitoring end or monitoring agent 550 to monitor the deployment running on the customer's cloud, on-premise, or hybrid infrastructure 560. The user may also be able to monitor a usage, an availability, and state of the deployment process. Further, the user may collect telemetry information from an intelligent monitoring end within the system 500 and pass the telemetry information to a backend core of the system 500. In addition, a smart agent within the system 500 can be configured to collect vital telemetry information from the deployment process.

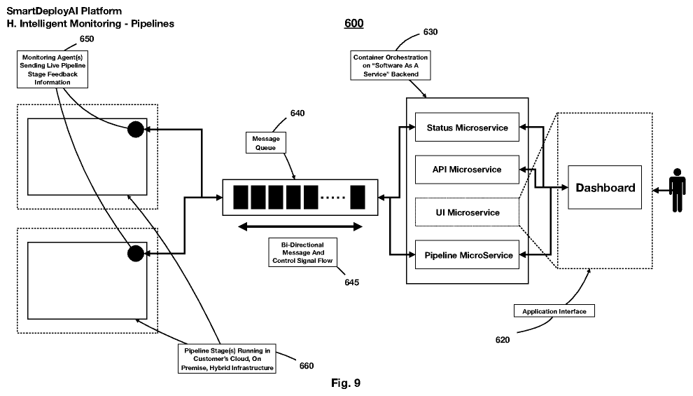

FIG. 9 illustrates a system 600 in which a user can receive live deployment feedback information of deployed data workflow pipelines. The system 600 can illustrate how the rate of data workflow pipelines can increase in a computer system. A user can access an application interface 620 to interface with during a deployment process. A container orchestration 630 with one or more microservices can arrange the services of the application modules, including the application modules that apply to the data workflow pipelines. A message queue 640 can pass the deployed infrastructure or data workflow pipelines with a bi-directional message and control signal flow 645 to the container orchestration 630 and to monitoring agents 650. The intelligent monitoring agents 650 can monitor the deployment running on the customer's cloud, on premise or hybrid infrastructure 660. The user can monitor a usage, availability and state of the deployment of the data workflow pipelines. The user can also collect feedback/telemetry information from an intelligent monitoring end as the different components and different stages of the pipeline execute. In addition, the user can also pass the telemetry information to a backend core of the system 600 as the different components and different stages of the pipeline execute. Further, the monitoring agents 650 may also collect vital telemetry information from the deployment process.

Exemplary user devices are illustrated in some of the figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiment, each data storage may be a relational database. Particular embodiments may provide interfaces that enable servers or clients to manage, e.g., retrieve, modify, add, or delete, the information stored in data storage.

While exemplary embodiments are described herein, it is not intended that these embodiments describe all possible forms of the invention. Rather, the words used in the specification are words of description rather than limitation, and it is understood that various changes may be made without departing from the scope of the invention. Additionally, the features of various implementing embodiments may be combined to form further embodiments of the invention.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

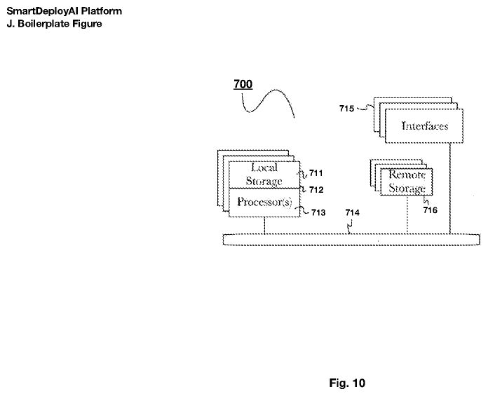

Referring now to FIG. 10, there is shown a block diagram depicting an exemplary computing device 700 suitable for implementing at least a portion of the features or functionalities disclosed herein. Computing device 700 may be, for example, any one of the computing machines listed in the previous paragraph, or indeed any other electronic device capable of executing software- or hardware-based instructions according to one or more programs stored in memory. Computing device 700 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 700 includes one or more central processing units (CPU) 712, one or more interfaces 715, and one or more buses 714 (such as a peripheral component interconnect (PCI) bus). When acting under the control of appropriate software or firmware, CPU 712 may be responsible for implementing specific functions associated with the functions of a specifically configured computing device or machine. For example, in at least one aspect, a computing device 700 may be configured or designed to function as a server system utilizing CPU 712, local memory 711 and/or remote memory 716, and interface(s) 715. In at least one aspect, CPU 712 may be caused to perform one or more of the different types of functions and/or operations under the control of software modules or components, which for example, may include an operating system and any appropriate applications software, drivers, and the like.

CPU 712 may include one or more processors 713 such as, for example, a processor from one of the Intel, ARM, Qualcomm, and AMD families of microprocessors. In some embodiments, processors 713 may include specially designed hardware such as application-specific integrated circuits (ASICs), electrically erasable programmable read-only memories (EEPROMs), field-programmable gate arrays (FPGAs), and so forth, for controlling operations of computing device 700. In a particular aspect, a local memory 711 (such as non-volatile random-access memory (RAM) and/or read-only memory (ROM), including for example one or more levels of cached memory) may also form part of CPU 712. However, there are many different ways in which memory may be coupled to system 700. Memory 711 may be used for a variety of purposes such as, for example, caching and/or storing data, programming instructions, and the like. It should be further appreciated that CPU 712 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 715 are provided as network interface cards (NICs). Generally, NICs control the sending and receiving of data packets over a computer network; other types of interfaces 715 may for example support other peripherals used with computing device 700. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 715 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 700 for implementing one or more of the embodiments described herein, it is by no means the only device architecture on which at least a portion of the features and techniques described herein may be implemented. For example, architectures having one or any number of processors 713 may be used, and such processors 713 may be present in a single device or distributed among any number of devices. In one aspect, single processor 713 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote storage block 716 and local storage 711) configured to store data, program instructions for the general-purpose network operations, or other information relating to the functionality of the embodiments described herein (or any combinations of the above). Program instructions may control execution of or comprise an operating system and/or one or more applications, for example. Memory 716 or memories 711, 716 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “SSD” storage drives that may combine physical components of solid state and hard disk drives in a single hardware device (as are becoming increasingly common in the art with regard to personal computers), storage memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### ADDITIONAL CONSIDERATIONS

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A method for utilizing an automated process for deploying infrastructure in a computer system using a graphical user interface (GUI), the method comprising:
receiving, via the GUI, a user selection to obtain one or more image containers from a container image registry;
removing the one or more image containers from the container image registry by a processor and managing the one or more image containers with other containers running by a container orchestration system; and
beginning the deployment setup by the processor when the one or more removed image containers are running by preparing necessary user infrastructure; and
provisioning the necessary user infrastructure onto an external cluster to complete the deployment setup.

2. The method of claim 1, wherein the image container is destroyed when the deployment setup is completed.

3. The method of claim 1, further comprising:
deploying a smart agent during the deployment setup.

4. The method of claim 1, wherein the deployment setup includes deploying one or more data pipelines.

5. The method of claim 4, wherein the one or more data pipelines each comprise at least one image container.

6. The method of claim 1, wherein a smart agent is installed during the deployment setup to collect vital telemetry information from the deployment setup.

7. The method of claim 1, a smart agent collects telemetry information from the deployment setup and passes the telemetry information to a backend core.

8. The method of claim 1, further comprising:
monitoring the infrastructure and collecting telemetry information on a state of the deployment setup.

9. A method for registering for a deployment of infrastructure within a computer system, the method comprising:
launching the deployment of infrastructure by a processor by sending a command to an application interface;
pulling at least one image container from an image container registry in response to the command to the application interface;
using the at least one image container by the processor to begin a deployment process by starting up necessary infrastructure and associated configurations on at least one external cluster; and
providing visual feedback on a state of the deployment process using a graphical user interface (GUI).

10. The method of claim 9, wherein a user is able to see the state of their deployment process inside of the application interface.

11. The method of claim 9, further comprising:
providing visual feedback on health and deployment resource usage patterns.

12. The method of claim 9, wherein one or more jobs on the deployment process is launched through the application interface.

13. The method of claim 9, further comprising:
providing visual feedback on a progress of jobs which were launched during the deployment process.

14. The method of claim 9, wherein the deployment process includes selecting an existing pipeline definition to deploy data pipelines.

15. The method of claim 9, wherein the deployment process includes deploying data pipelines in a sequential order.

16. The method of claim 9, wherein the deployment process includes deploying data pipelines in a parallel sequence.

17. A system for increasing a rate of a deployment of computer infrastructure in a computer-readable medium, the system comprising:
an application interface with one or more application modules for user interfacing to initiate a deployment process;
a backend core connected to the application interface, containing a container image registry which is accessed by a processor to pull one or more container images to begin the deployment process and set up necessary user infrastructure;
an external cluster configured to receive the one or more container images to enable the necessary user infrastructure to be deployed; and
an intelligent monitoring end connected to the backend core, providing visual feedback on a usage, an availability and state of the deployment process.

18. The system of claim 17, wherein the deployment process includes uploading a pipeline definition.

19. The system of claim 17, wherein the deployment process includes deploying data pipelines and executing the data pipelines in a plurality of stages.

20. The system of claim 17, wherein the backend core contains setup images for additional deployments of user infrastructure.
